(19) United States
(12) Patent Application Publication
(10) Pub. No.: US 2026/0233330 A1
(43) Pub. Date: Aug. 13, 2026

(54) LASER ANNEALING WITH LINEARLY POLARIZED LASER RADIATION

(71) Applicant: Coherent LaserSystems GmbH & Co. KG, Göttingen (DE)

(72) Inventor: Paul Christiaan VAN DER WILT, Göttingen (DE)

(73) Assignee: Coherent LaserSystems GmbH & Co. KG, Göttingen (DE)

(21) Appl. No.: 19/535,100

(22) Filed: Feb. 10, 2026

Related U.S. Application Data
(60) Provisional application No. 63/758,136, filed on Feb. 13, 2025.

(51) Int. Cl. B23K 26/0622; B23K 26/06; B23K 26/067; B23K 26/073

(52) U.S. Cl. CPC B23K 26/0624; B23K 26/0608; B23K 26/0676; B23K 26/0736

(57) ABSTRACT

A laser annealing method includes generating linearly-polarized pulsed laser radiation using one or more pulsed laser sources and forming a pulsed line beam from the linearly-polarized pulsed laser radiation. The line beam has mutually-orthogonal short and long axes and contains two linear polarization components that are symmetrically inclined with respect to the short axis. A target substrate is laser annealed by scanning the target substrate with the line beam. Each to-be-annealed location on the target substrate is exposed to a series of pulses of the line beam. When the two polarization components have the same power, any resulting non-zero net-polarization of the line beam is along the short or long axis. The method is compatible with solid-state lasers and may mix beams from multiple laser sources such that each laser source contributes to both polarization components of the line beam.

### CROSS-REFERENCE TO RELATED APPLICATIONS

This application claims the benefit of U.S. Provisional Application No. 63/758,136, filed Feb. 13, 2025, the entire contents of which is incorporated herein by reference.

### TECHNICAL FIELD OF THE INVENTION

The present invention relates generally to laser annealing, such as silicon laser annealing in the fabrication of flat-panel displays. The present invention relates in particular to optimizing the microstructure produced by laser annealing with polarized laser radiation.

### DISCUSSION OF BACKGROUND ART

Flat-panel displays form the basis of many modern electronic devices, including smartphones, tablets, laptops, and televisions. Active-matrix liquid-crystal displays (AMLCDs) and active-matrix organic light-emitting diode (AMOLED) displays are the two most commonly used flat-panel display technologies. Both utilize a backplane consisting of a glass substrate with numerous thin-film transistors that form the pixel circuitry. In AMLCDs, the backplane is backlit, and the thin-film transistors control the orientation of liquid crystal molecules. In turn, the liquid crystal molecules modulate the transmission of the backlight through the backplane to display the desired image. AMOLED displays, a matrix of organic LEDs (OLED) is formed on the backplane. The emission from each OLED is controlled by a corresponding thin-film transistor.

The thin-film transistors are formed by first depositing a thin silicon layer on the glass substrate of the display backplane and then patterning this silicon layer. The thin silicon layer may have a thickness of about 50 nanometers (nm). The thin silicon layer is initially deposited on the glass substrate by chemical vapor deposition, whereby the thin silicon layer is amorphous. Amorphous silicon has a highly irregular and disordered atomic structure, resulting in an electron mobility of only around 0.5 square-centimeters per Volt·seconds (cm²/Vs). This electron mobility is insufficient for AMLCDs and AMOLED displays of most consumer products, which in most cases require high resolution and therefore small thin-film transistors while also requiring high switching speed. Additionally, in AMCLDs, the footprint occupied by the thin-film transistors on the glass substrate must be small in order to block as little backlight as possible, so as to achieve high brightness with low power consumption. In AMOLED displays, this is not a concern. However, each OLED demands a substantial current draw through the thin-film transistor in order to produce bright and stable emission. Thus, the thin-film transistors of both AMLCDs and AMOLED displays require a higher electron mobility than that of amorphous silicon.

Single-crystal silicon has a high electron mobility of about 600 cm²/Vs, but the epitaxial growth process required to produce single-crystal silicon is not compatible with flat panel displays. Instead, the electron mobility needed for the thin-film transistors is achieved by crystallizing the amorphous silicon after deposition. The crystallization process transforms the disordered atomic structure of amorphous silicon into a more ordered polycrystalline structure with many small silicon crystals (i.e., grains) of different orientations. The electron mobility of polycrystalline silicon is much higher than that of amorphous silicon, more specifically in the range between 50 and 250 cm²/Vs. The crystallization process is a critical step that enables the manufacture of flat panel displays with the appearance and power consumption demanded by the modern consumer.

Laser annealing has emerged as a preferred method for silicon crystallization in display manufacturing. The laser annealing process involves irradiating the amorphous silicon layer with high-energy laser pulses, causing localized melting and subsequent recrystallization into a polycrystalline structure. The quality and uniformity of the resulting polycrystalline silicon directly impact the performance characteristics of the thin-film transistors and, consequently, the overall display quality.

Excimer lasers, particularly those utilizing krypton fluoride (KrF) or xenon chloride (XeCl), have traditionally been employed for laser annealing in display manufacturing. Excimer lasers are gas-discharge lasers that generate high-power ultraviolet radiation through the formation of excited dimers. These lasers typically use a mixture of noble gases and halogens (e.g., KrF or XeCl) as the gain medium, and the excited dimers are typically generated by a radio-frequency discharge pulse. Excimer lasers may emit at wavelengths between 157 nm and 351 nm, depending on the specific gas mixture used. These short wavelengths in the ultraviolet region make excimer lasers particularly suitable for laser annealing of silicon. In terms of output characteristics, excimer lasers may generate pulse energies ranging from 10 milliJoules (mJ) to 1 Joule (J), with typical pulse durations being in the nanosecond range. Some excimer lasers operate at repetition rates up to one kilohertz (kHz) or higher. In a typical laser annealing application, each location to be annealed is subjected to several excimer laser pulses. To anneal large substrate areas, the excimer laser output may be shaped into a line beam with a length of several hundred millimeters (mm) and a width of less than 1 mm, and the line beam may be scanned across the substrate.

### SUMMARY OF THE INVENTION

While excimer lasers have been widely used for laser annealing, a solid-state laser architecture is an appealing alternative for multiple reasons. For example, solid-state lasers require less maintenance than excimer lasers. Due to the corrosive nature of the halogen gas in excimer lasers, regular excimer laser maintenance includes gas refills and cleaning/replacement of surfaces corroded by the halogen gas. No such maintenance is required for a solid-state laser. In general, solid-state lasers are cleaner, more compact, simpler to operate, and more efficient than excimer lasers.

Producing the desired wavelength with a solid-state laser may entail frequency conversion in one or more nonlinear crystals. The output beam of most solid-state laser systems, especially when implementing nonlinear frequency-conversion, is at least partially polarized. This polarization creates effects in laser annealing that are not present with the non-polarized laser radiation generated by typical excimer lasers. For example, we have found that a net-polarization that is at an oblique angle to the axes of the line beam is disadvantageous. Such an obliquely oriented net-polarization has been found to have an adverse effect on the microstructure of the crystalline material produced by the annealing process. We have also observed an adverse impact on the microstructure from too strong a net-polarization along the long axis of the line beam.

The presently disclosed approach to laser annealing utilizes linearly polarized laser radiation to generate the line beam and is thus compatible with solid-state lasers. To avoid, or at least reduce, adverse polarization-related effects on the microstructure of the crystalline annealed material, each pulse of the line beam used in the presently disclosed approach contains a pair of linear polarization components. These linear polarization components are symmetrically inclined from the short axis of the line beam. The pair of symmetrically inclined polarization components can, for example, be produced by (a) evenly splitting a linearly polarized laser beam to produce two output laser beams and then (b) through one or more physical beam-reflections, flipping the polarization direction of one of the two laser beams relative to the other one. When the pair of symmetrically inclined polarization components have the same power, any resulting net-polarization of the line beam is along either the short axis or the long axis. A desired short-to-long-axis polarization extinction ratio can be achieved by adjusting the angle by which the two polarization components are symmetrically inclined from the short axis. In this manner, the net-polarization of the line beam can be optimized for different laser annealing applications. Benefitting from these polarization characteristics, microstructure properties rivaling or even outperforming those achieved in excimer laser annealing have been demonstrated with a solid-state laser annealing apparatus operating according to the presently disclosed laser annealing approach.

In some scenarios, it is advantageous to operate with a particularly long line beam to improve throughput. In these scenarios, laser radiation from multiple laser sources may be combined to produce the required power density along the full length of the line beam. When applied to systems with multiple laser sources, the presently disclosed laser annealing approach may include mixing the input beams from the multiple laser sources such that each laser source contributes to both of the two symmetrically inclined polarization components of the line beam. Such beam mixing minimizes adverse effects originating in differences between the input beams.

The presently disclosed approach is extendable to the inclusion of two or more symmetrically-inclined polarization-component pairs in each pulse of the line beam. These different polarization-component pairs may be characterized by different respective polarization-inclination angles and thus produce different respective net-polarizations of the line beam. Yet, by virtue of being symmetrically inclined with respect to the short axis, any net-polarization produced by each of the polarization-component pairs is along either the short or the long axis. Intra-pulse variation in the net-polarization of the line beam can be achieved by temporal offsets between the different polarization-component pairs, while still ensuring that any net-polarization is along the short or long axis.

In one aspect of the invention, a laser annealing method includes steps of generating linearly-polarized pulsed laser radiation using one or more pulsed laser sources and forming a pulsed line beam from the linearly-polarized pulsed laser radiation. The line beam has mutually-orthogonal short and long axes. The line beam contains a pair of linear polarization components that are symmetrically inclined with respect to the short axis and collaboratively produce a non-zero net-polarization along the long or short axis of the line beam. The laser annealing method also includes a step of laser annealing a target substrate by scanning the target substrate with the line beam, wherein each of a plurality of to-be-annealed locations on the target substrate is exposed to a series of pulses of the line beam.

In another aspect of the invention, a laser annealing method includes steps of generating linearly-polarized pulsed laser radiation using one or more pulsed laser sources and forming a pulsed line beam from the linearly-polarized pulsed laser radiation. The line beam has mutually-orthogonal short and long axes. The line beam contains a pair of linear polarization components that are (a) symmetrically inclined with respect to the short and long axes and (b) temporally synchronized with each other in each pulse of the line beam. The laser annealing method also includes a step of laser annealing a target substrate by scanning the target substrate with the line beam, wherein each of a plurality of to-be-annealed locations on the target substrate is exposed to a series of pulses of the line beam.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a laser annealing apparatus utilizing linearly polarized laser radiation to laser anneal a target substrate, according to an embodiment.

FIG. 2 is a flowchart for a laser annealing method that utilizes linearly polarized laser radiation to anneal a target substrate, according to an embodiment. This method may be performed by the FIG. 1 apparatus.

FIG. 3 illustrates certain aspects of an annealing step of the FIG. 2 method in further detail, in an example where a line beam is formed on a surface of a target substrate that includes a to-be-annealed layer.

FIG. 4 illustrates, by example, how scanning in the annealing step of the FIG. 2 method subjects each to-be-annealed location to multiple pulses of line beam.

FIGS. 5A and 5B schematically illustrate two examples of symmetrically inclined polarization components of the line beam performing laser annealing in the FIG. 1 apparatus and the FIG. 2 method.

FIG. 6 shows temporal profiles of two temporally-synchronized symmetrically inclined polarization components within a pulse of the line beam performing laser annealing in the FIG. 1 apparatus and the FIG. 2 method, together with a pulse of the line beam formed by these two polarization components, according to an embodiment.

FIG. 7 shows temporal profiles of two symmetrically inclined polarization components within a pulse of the line beam performing laser annealing in the FIG. 1 apparatus and the FIG. 2 method, together with a pulse of the line beam formed by these two polarization components, in an exemplary scenario where there is a delay between the two polarization components.

FIGS. 8A and 8B are orthogonal cross-sectional views of a beam-combination module that utilizes imaging-type beam-homogenization to combine two symmetrically inclined polarization components into the line beam performing laser annealing in the FIG. 1 apparatus and the FIG. 2 method, according to an embodiment.

FIG. 9 is a cross-sectional view of composite laser beam as incident on the FIG. 8 module, according to an embodiment. In this composite laser beam, the two symmetrically inclined polarization components are arranged side by side.

FIG. 10 is a cross-sectional view of another composite laser beam as incident on the FIG. 8 module, according to an embodiment. This composite laser beam contains four input beams.

FIG. 11 illustrates a beam-splitting and polarization-flipping module that may be implemented in a beam-delivery subsystem of the FIG. 1 laser annealing apparatus to produce two symmetrically inclined polarization components, according to an embodiment.

FIG. 12 illustrates a polarization-flipping technique employed in the FIG. 11 module.

FIG. 13 illustrates a beam-mixing module that mixes two input laser beams to produce symmetrically inclined polarization components that each contain contributions from each of the two input laser beams, according to an embodiment.

FIG. 14 illustrates another beam-mixing module that partly integrates mixing and polarization manipulation functions to produce a pair of output laser beams with symmetrically inclined polarization directions, according to an embodiment.

FIG. 15 illustrates a composite laser pulse that contains temporally offset sub-pulses with different respective polarization configurations, each of which contains two symmetrically inclined polarization components, according to an embodiment.

FIG. 16 illustrates a laser system that produces two pairs of symmetrically inclined polarization components from two linearly polarized input laser beams, according to an embodiment.

FIG. 17 illustrates a laser system that produces two pairs of symmetrically inclined polarization components from the mixed outputs of two linearly polarized laser sources, according to an embodiment.

### DETAILED DESCRIPTION OF THE INVENTION

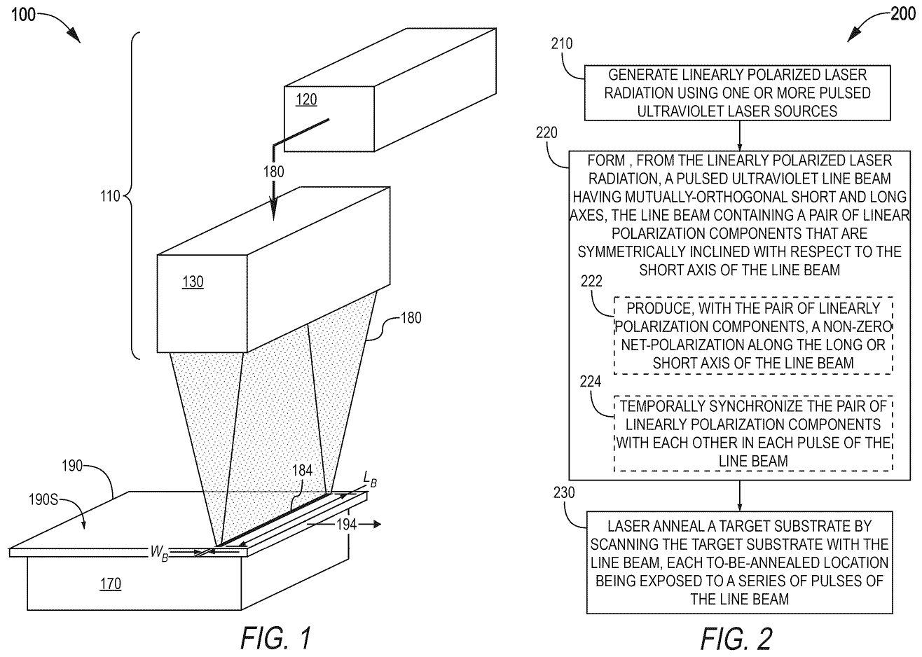

Referring now to the drawings, wherein like components are designated by like numerals, FIG. 1 illustrates one laser annealing apparatus 100 utilizing linearly polarized laser radiation to laser anneal a target substrate 190. Apparatus 100 includes a laser system 110 and a fixture 170. Laser system 110 includes one or more pulsed laser sources 120 and a beam-delivery subsystem 130. Each laser source 120 may be an ultraviolet laser source.

FIG. 2 is a flowchart for a laser annealing method 200 that utilizes linearly polarized laser radiation to anneal a target substrate. Method 200 may be performed by apparatus 100. In the following, method 200 is discussed as applied to apparatus 100. FIGS. 1 and 2 are best viewed together.

Herein, the term “linearly polarized” refers to laser radiation, a laser beam, or a component of a laser beam/laser radiation that is characterized by a net-polarization that is linear. Stated differently, the term “linearly polarized” refers to laser radiation, a laser beam, or a component of a laser beam/laser radiation with a polarization state that is in the S₁-S₂ plane of the Poincaré sphere, wherein S₁ and S₂ are the first two Stokes parameters. Each of linearly polarized laser radiation, a linearly polarized laser beam, and a linear polarization component may be composed of (a) a single, pure linear polarization component, (b) a plurality of non-parallel pure linear polarization components that add up to produce a linear net-polarization, or (c) partially polarized laser radiation characterized by a linear net-polarization. A “pure linear polarization component” is a beam component composed of laser light polarized along the same linear direction. The polarization direction of linearly polarized laser radiation, a linearly polarized laser beam, or a linearly polarization component (as these terms are defined above) refers to the direction of a linear net-polarization thereof.

In a laser-radiation-generation step 210 of method 200, laser source(s) 120 generate linearly polarized laser radiation 180. Each laser source 120 may be a solid-state laser source, for example a frequency-doubled or frequency-tripled laser having a diode-pumped gain crystal. The frequency-doubling or tripling may be achieved with lithium triborate and/or beta barium borate crystals. The gain crystal may be an ytterbium or neodymium doped yttrium aluminum garnet or yttrium orthovanadate gain crystal. Each laser source 120 may generate a laser beam that is composed of a single pure linear polarization component or composed of two mutually-orthogonal linear polarization components of unequal power. In one embodiment, laser radiation 180 is ultraviolet with a wavelength less than 400 nm, for example in the range between 150 and 400 nm. In another embodiment, laser radiation is visible, for example green or blue.

In a line-beam-forming step 220 of method 200, beam-delivery subsystem 130 forms a pulsed line beam 184 from linearly polarized laser radiation 180. Line beam 184 has mutually-orthogonal short and long axes. Line beam 184 has a length L_{B} in its long-axis dimension and a width W_{B} in its short-axis dimension. Length L_{B} exceeds width W^{B}. Length L_{B} may be up to one or more meters. In one example, length L_{B} is at least 50 centimeters (cm), e.g., in the range between 0.75 and 1.5 meters. Width W_{B} may be less than 1 millimeter (mm), for example in the range between 200 and 600 micrometers (μm).

An annealing step 230 of method 200 laser anneals a target substrate 190 by scanning target substrate 190 with line beam 184. Target substrate 190 is held or supported by a fixture 170 in apparatus 100.

Apparatus 100 may include a scanning system to aid annealing step 230. In one implementation, fixture 170 includes a motion stage that translates target substrate 190 through line beam 184 in a scanning direction 194. Scanning direction 194 is typically orthogonal to the long axis of line beam 184. In another implementation, target substrate 190 is stationary, and laser system 110 (or a portion thereof) is equipped with a motion stage or optical beam-steering functionality to scan line beam 184 across target substrate 190 in, e.g., a direction orthogonal to the long axis of line beam 184. Yet another implementation combines translation of target substrate 190 with translation/steering of line beam 184 to address the desired areas of target substrate 190. For example, laser system 110 may be equipped to scan line beam 184 in one dimension (e.g., orthogonal to the long axis of line beam 184), while fixture 170 is configured to translate target substrate 190 in the orthogonal dimension.

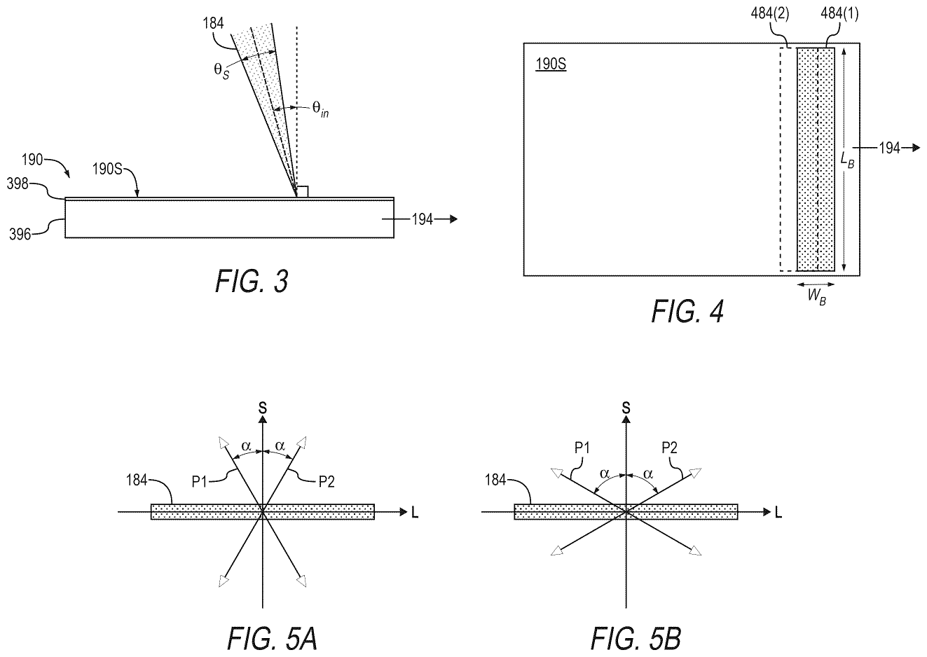

FIG. 3 is a cross-sectional view showing certain aspects of annealing step 230 in further detail, in an example where line beam 184 is formed on a surface 190S of target substrate 190 that includes a to-be-annealed layer. In this example, target substrate 190 includes a carrier substrate 396 with a to-be-annealed layer 398 disposed thereon. In one example, layer 398 is a layer of amorphous silicon that is crystallized into polycrystalline silicon in annealing step 230 of method 200. After laser annealing by method 200, this example of target substrate 190 may be subjected to other manufacturing processes to produce a backplane of a flat-panel display. The thickness of the amorphous silicon layer may be in the range between 20 and 100 nm.

Regardless of the composition of target substrate 190, line beam 184 is incident on substrate surface 190S at an incidence angle θin that may be zero or non-zero. In one example, incidence angle θᵢₙ is in the range between 0 and 15 degrees. Line beam 184 typically has a larger angular distribution, i.e., angular spread, in its short axis than in its long axis. The cross section of FIG. 3 is taken parallel to the short axis and indicates a short-axis angular spread θ_{S}. In one example, short-axis angular spread θ_{S} is between 5 and 30 degrees, while the corresponding long-axis angular spread θ_{L} (not shown in FIG. 3) is less than 5 degrees.

FIG. 4 illustrates, by example, how scanning in annealing step 230 subjects each of a plurality of to-be-annealed locations to multiple pulses of line beam 184. In the depicted example, scanning direction 194 is orthogonal to the long axis of line beam 184. This is advantageous because of the elongated shape of line beam 184. FIG. 4 shows the respective areas irradiated by two subsequent pulses 484(1) and 484(2) of line beam 184. The scan speed along direction 194 relates to the pulse repetition rate of line beam 184 such that the respective areas irradiated by pulses 484(1) and 484(2) overlap. The overlap region is irradiated by both pulse 484(1) and pulse 484(2). More generally, the scan speed along direction 194 relates to the pulse repetition rate of line beam 184 such that each to-be-annealed location is subjected to a series of laser pulses, for example between 10 and 100 laser pulses, or between 20 and 40 pulses.

Referring again to FIGS. 1 and 2 and line-beam-forming step 220, line beam 184 contains a pair of linear polarization components that are symmetrically inclined with respect to the short axis of line beam 184. These two symmetrically inclined polarization components are beneficial for achieving a desired microstructure of the material annealed by line beam 184 in annealing step 230.

FIGS. 5A and 5B are plan views of surface 190S that schematically illustrate two examples of the symmetrically inclined polarization components of line beam 184. Each of FIGS. 5A and 5B depicts line beam 184 in a plane spanned by its short axis S and long axis L. Line beam 184 contains two symmetrically inclined polarization components P1 and P2. Polarization component P1 is inclined from short axis S by an angle α. Polarization component P2 is also inclined from short axis S by angle α but in the opposite direction than polarization component P1. In the FIG. 5A example, polarization-inclination-angle α is less than 45 degrees. In a scenario, where polarization components P1 and P2 have the same power, the polarization configuration of FIG. 5A produces a linear net-polarization along short axis S. In the FIG. 5B example, polarization-inclination-angle α exceeds 45 degrees, thus producing a linear net-polarization along long axis L in the scenario where polarization components P1 and P2 have the same power. More generally, polarization-inclination-angle α is between 0 and 90 degrees, although a polarization-inclination-angle α of exactly 0 or 90 degrees corresponds to the two polarization components being one and the same.

Each of polarization components P1 and P2 may be (a) a pure linear polarization component, (b) a mixture of two or more pure polarization components that add up to produce a linear net-polarization, or (c) partially polarized laser radiation with a linear net-polarization. In examples where polarization component P1 or P2 is not pure, the polarization may be characterized by a polarization extinction ratio of at least 60:40, at least 70:30, or at least 90:10.

In one embodiment, each pulse of line beam 184 is composed of polarization components P1 and P2. In another embodiment, at least 90% of the energy of each pulse of line beam 184 is composed of polarization components P1 and P2.

Although not shown in FIG. 2, method 200 may include a step of adjusting polarization-inclination-angle α to achieve a desired net-polarization of line beam 184. For example, polarization-inclination-angle α may be adjusted to determine an optimal value thereof, or set it to an optimal value, for a particular laser annealing application. Polarization-inclination-angle α is for example adjusted by rotating one or more halfwave plates. In certain embodiments, it is sufficient to rotate the polarization of a single laser beam, which may be achieved by rotating a single halfwave plate.

In general, whether utilizing method 200 or another laser line-beam annealing method, the quality of laser annealing is affected by a multitude of mechanisms occurring in the interaction between the line beam and the irradiated target material. The different crystalline domains of the annealed material define a microstructure. For some applications, the microstructure is, ideally, a checkerboard with high regularity and with similar properties in the dimensions corresponding to the short and long axes of line beam 184. Differences in short-axis and long-axis laser parameters (e.g., a non-zero incidence angle θᵢₙ, and differences between short-axis angular spread θS and long-axis angular spread θ_{L}) may introduce differences between the corresponding dimensions of the microstructure. Additionally, and of particular relevance to the use of solid-state lasers, polarization induces microstructure along the polarization direction.

Method 200 is tailored to reduce adverse effects from polarization. Method 200 also offers the opportunity to tune the net-polarization of the line beam to be optimal for any given laser annealing application. Preferably, any net-polarization of line beam 184 is parallel to either short axis S or long axis L. An obliquely oriented net-polarization has been found to be disadvantageous for the microstructure development. When the symmetrically inclined polarization components P1 and P2 produced by apparatus 100 have the same power, any net-polarization is necessarily parallel to either short axis S or long axis L. This holds true regardless of the magnitude of polarization-inclination-angle α. Without departing from the scope hereof, deviations from exact alignment with the short or long axis may exist, for example due to polarization imperfections or polarization-sensitive attenuation. In one scenario, any non-zero net-polarization of line beam 184 is parallel with short axis S or long axis L to within 5 degrees.

When polarization components P1 and P2 have the same power, polarization-inclination-angle α alone determines the short-to-long-axis polarization extinction ratio of line beam 184. The short-to-long-axis polarization extinction ratio affects the respective microstructure development in the dimensions corresponding to the short and long axes. A desired microstructure may be achieved by adjusting polarization-inclination-angle α. Within the context of silicon-annealing, it may be advantageous to set polarization-inclination-angle α such that the short-to-long axis polarization extinction ratio of line beam 184 is in the range between 80:20 and 20:80, or even between 70:30 and 30:70. In some scenarios, this relatively moderate net-polarization produces a more desirable microstructure than a stronger net-polarization. These ranges could exclude a polarization extinction ratio of 50:50, which would not provide net linear polarization. For example, these ranges may exclude polarization extinction ratios between 52:48 and 48:52, and even between 55:45 and 45:55.

In most scenarios, the optimal short-to-long axis polarization extinction ratio will be different from 50:50, such that there is a non-zero net-polarization along either short axis S or long axis L. In a corresponding embodiment of method 200, line-beam-forming step 220 includes a step 222 of producing, with polarization components P1 and P2, a non-zero net-polarization along either short axis S or long axis L. For polarization components P1 and P2 of the same power, this embodiment corresponds to polarization-inclination-angle α being different from 45 degrees. Each pulse of line beam 184 may have a non-zero net-polarization along either short axis S or long axis L.

To avoid potentially adverse effects from too strong a net-polarization along either one of short axis S and long axis L, line-beam-forming step 220 may include a step 224 of temporally synchronizing polarization components P1 and P2 in each pulse of line beam 184.

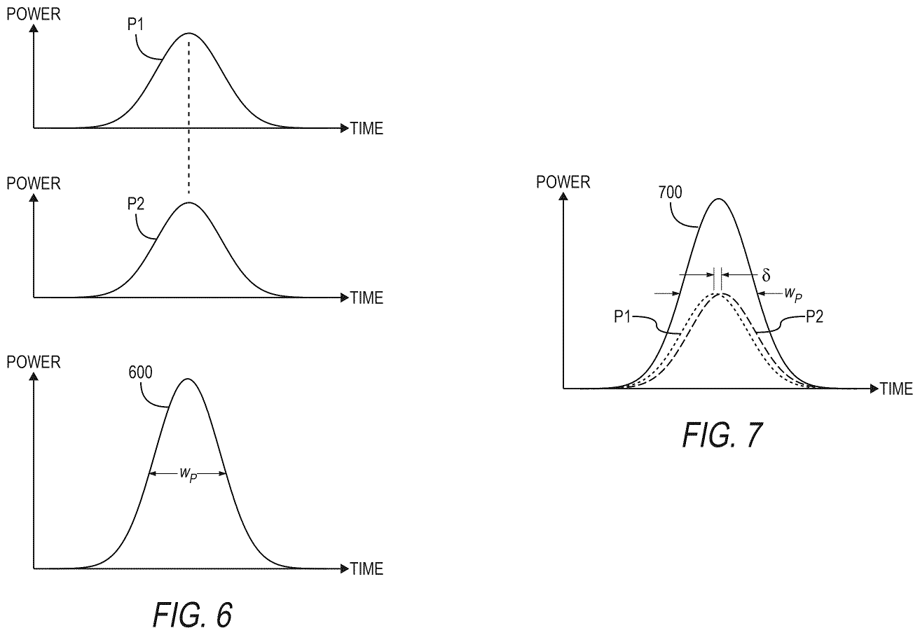

FIG. 6 shows temporal profiles of polarization component P1 and polarization component P2 within a pulse 600 of line beam 184 in a scenario where the temporal synchronization of polarization components P1 and P2 is perfect. This situation arises when step 224 of method 200 is performed to perfection. The upper two plots show the temporal profiles of polarization components P1 and P2, respectively. In the depicted case, the temporal profiles of polarization components P1 and P2 have the same shape and no temporal delay therebetween. The lowest plot shows the temporal profile of pulse 600 formed by polarization components P1 and P2 together. At all times throughout its pulse duration, pulse 600 contains both polarization component P1 and polarization component P2. Pulse 604 has a temporal width w_{P} that equals the temporal width of each of polarization components P1 and P2. Herein, a temporal width may refer to a full-width at half-maximum width or a 1/e² width.

FIG. 7 shows temporal profiles of polarization components P1 and P2, as well as a pulse 700 of line beam 184 formed by the combination of polarization components P1 and P2 in a scenario where there is a delay δ between the respective temporal centers of polarization components P1 and P2. In practical implementations, it may be difficult to achieve perfect synchronization between polarization components P1 and P2. Thus, without departing from the scope hereof, polarization components P1 and P2 may be offset from each other by a small delay δ in step 224 of method 200. For example, polarization components P1 and P2 may be considered temporally synchronized when delay δ is less than 10 percent of the width w_{P} of pulse 700.

In certain embodiments of method 200, polarization components P1 and P2 have the same pulse energy, at least to within a practically reasonable accuracy. Polarization components P1 and P2 may be considered having equal pulse energy, when their respective pulse energies differ by less than 20 percent or by less than 10 percent. When combined with temporal synchronization, equal pulse energies result in optimal balancing of polarization components P1 and P2, and thereby optimal alignment of any resulting net-polarization with short axis S or long axis L.

The combination of polarization components P1 and P2 into line beam 184, in line-beam-forming step 220 of method 200, may be performed in a variety of ways. In one embodiment, each of polarization components P1 and P2 is shaped into a line beam by a separate respective optical system in such a fashion that the two respective line beams are formed in the same location. In this embodiment, the two line beams may be incident on target substrate 190 at slightly different incidence angles θᵢₙ. In another embodiment, homogenization by, e.g., one or more microlens arrays, mixes polarization components P1 and P2 while shaping the mixed laser radiation into line beam 184.

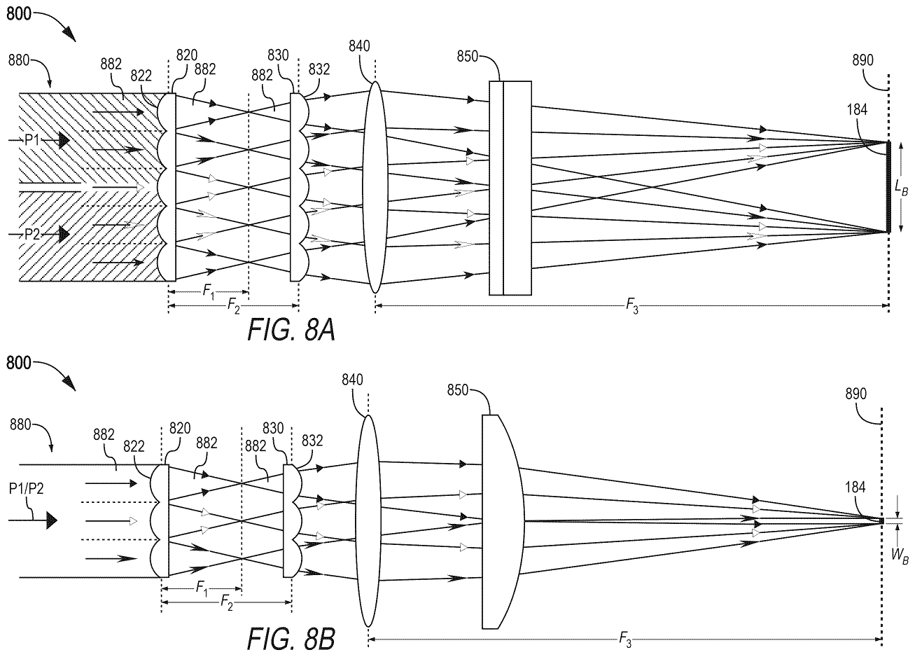

FIGS. 8A and 8B are orthogonal cross-sectional views of one beam-combination module 800 that utilizes imaging-type beam-homogenization to combine polarization components P1 and P2 into line beam 184. Module 800 may be implemented in beam-delivery subsystem 130 of apparatus 100. Advantageously, the beam-homogenization performed by module 800 (a) distributes both of polarization components P1 and P2 along the full length of line beam 184 and (b) homogenizes the intensity distribution of each of polarization components P1 and P2 within line beam 184. The FIG. 8A cross section is parallel to the lengthwise axis of line beam 184, and the FIG. 8B cross section is parallel to the widthwise axis of line beam 184. Although not shown in FIGS. 8A and 8B, the optical axis of module 800 may be folded and/or rotated. In embodiments of module 800 with a folded and/or rotated optical axis, the diagrams of FIGS. 8A and 8B represent beam propagation in a frame that follows the optical axis.

Module 800 includes two microlens arrays 820 and 830, a focusing lens 840, and a cylindrical lens 850. Module 800 is configured to receive a composite laser beam 880 composed of polarization components P1 and P2.

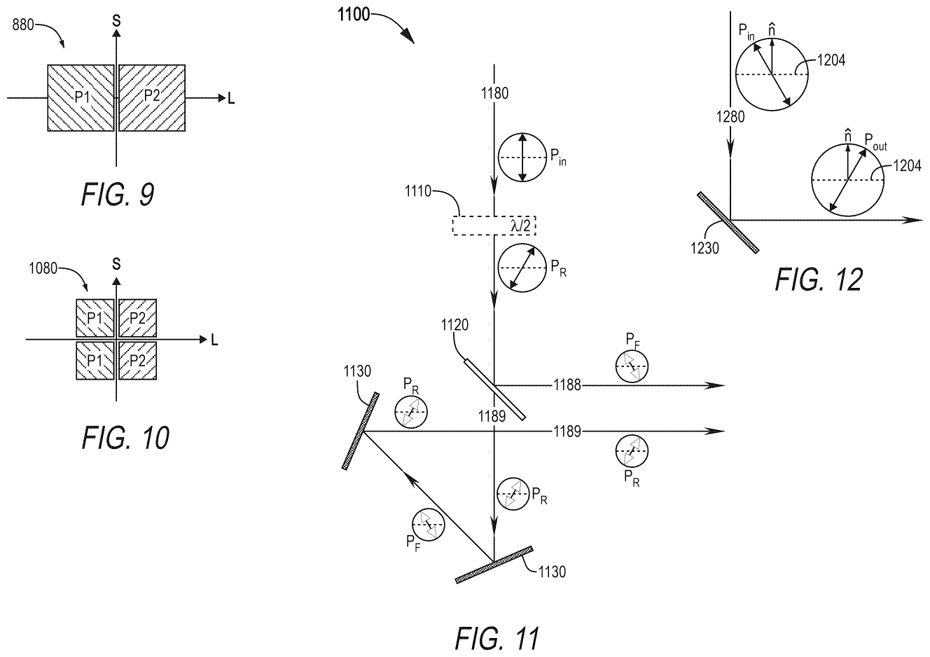

FIG. 9 is a cross-sectional view of composite laser beam 880 as incident on module 800. In composite laser beam 880, polarization components P1 and P2 are arranged side by side and with substantially parallel propagation directions. A gap may or may not exist between polarization components P1 and P2 when incident on module 800.

Referring now to beam propagation in the lengthwise plane shown in FIG. 8A, cylindrical lens 850 has substantially zero optical power in the lengthwise dimension. FIG. 8A therefore provides the simplest depiction of beam combination and homogenization. At a high level, microlens array 820 segments composite laser beam 880 into an array of beamlets 882. Each beamlet 882 is indicated in FIGS. 8A and 8B by its peripheral rays, and different arrow types are used to distinguish different beamlets 882 from each other. Microlens array 830 and focusing lens 840 then cooperate to image each beamlet 882 from microlens array 820 to a target plane 890 such that the images of beamlets 882 are overlayed on each other in target plane 890. In this manner, each beamlet 882 is imaged to substantially the full length of line beam 184 formed in target plane 890.

Each beamlet 882 originates from a different respective portion of composite laser beam 880. In the depicted example, there are five beamlets 882 in each lengthwise cross section. Two of these beamlets 882 contain respective portions of polarization component P1. Another two of these beamlets 882 contain respective portions of polarization component P2. A fifth and middle beamlet 882 contains a portion of each of polarization components P1 and P2. The overlaying of beamlets 882 in target plane 890 combines polarization components P1 and P2 into line beam 184. Furthermore, the beam homogenization ensures that, at least to first order, the relative weighting between polarization components P1 and P2 is substantially constant along the length of line beam 184. In addition, the beam homogenization reduces the appearance in line beam 184 of any spatial non-uniformities in either one of polarization components P1 and P2. Practical implementations may form many more than five beamlets 882 in each lengthwise cross section to improve the homogenization.

In further detail, each beamlet 882 is formed by a microlens 822 of microlens array 820 and subsequently focused by a corresponding microlens 832 of microlens array 830 as well as by focusing lens 840. Microlenses 822 have focal length F₁, and microlenses 832 have focal length F₂. In the depicted embodiment, the distance between microlens arrays 820 and 830 matches focal length F₂. Focal length F₂ of microlenses 832 may equal or exceed focal length F₁ of microlenses 822. In the depicted embodiment, focal length F₂ exceeds focal length F₁ in order to avoid focusing beamlets 882 tightly on the surface of microlens array 830. The distance from focusing lens 840 to target plane 890 matches the focal length F₃ of focusing lens 840, whereby focusing lens 840 directs all beamlets 882 to the same location on target plane 890. At the same time, the combined optical powers of microlens array 830 and focusing lens 840 image each beamlet 882 from microlens array 820 to target plane 890. Focusing lens 840 alone cannot meet this imaging condition simultaneously for all beamlets 882. With the imaging condition being met, the lengthwise intensity distribution of line beam 184 may resemble a top-hat.

Consider now FIG. 8B and beam propagation in the widthwise plane. Cylindrical lens 850 imposes additional focusing in the widthwise transverse dimension to produce line beam 184 with a narrow width WB. Due to this additional focusing by cylindrical lens 850, the imaging condition from microlens array 820 to target plane 890 is not met for the widthwise transverse dimension. However, laser annealing applications typically do not have the same requirements for beam uniformity in the widthwise dimension as in the lengthwise dimension. In the widthwise dimension, the primary objective is instead to achieve a narrow width in order to increase the laser intensity.

In an alternative embodiment, not depicted, microlens array 830 is omitted, and focusing lens 840 overlays beamlets 882 on each other in target plane 890 without meeting the condition for imaging beamlets 882 from microlens array 820 to target plane 890. This non-imaging beam-homogenization technique may provide excellent mixing and homogenization of polarization components P1 and P2. However, the resulting line beam 184 may deviate more from a top-hat intensity profile due to the imaging condition not being met. The beam combination technique utilized in module 800, or the alternative non-imaging embodiment, is readily extendable to receiving more than two input beams.

FIG. 10 is a cross-sectional view of another composite laser beam 1080 containing four input beams. Composite laser beam 1080 may be combined into line beam 184 by module 800 or its alternative non-imaging embodiment. Composite laser beam 1080 contains two beams of polarization component P1 and two beams of polarization component P2. Although not shown in FIG. 10, a gap may exist between some of the four beams of composite laser beam 1080 when incident on module 800.

FIG. 11 illustrates a beam-splitting and polarization-flipping module 1100 that may be implemented in beam-delivery subsystem 130. From one linearly polarized laser beam 1180, module 1100 produces two output laser beams with symmetrically inclined linear polarizations. When implemented in beam-delivery subsystem 130, module 1100 converts a linearly polarized laser beam to polarization components P1 and P2. These polarization components P1 and P2 may then subsequently be combined into line beam 184, for example by module 800 or its alternative non-imaging embodiment.

FIG. 12 illustrates a polarization-flipping technique employed in module 1100. A linearly polarized laser beam 1280 is reflected by a mirror 1230. Laser beam 1280 is incident on mirror 1230 with a polarization direction that is at an oblique angle to the propagation plane defined by mirror 1230 and the initial propagation direction of laser beam 1280. Each polarization diagram in FIG. 12 indicates the polarization direction of laser beam 1280 relative to the propagation plane 1204 and a normal vector \hat{n} to propagation plane 1204. Upon reflection by mirror 1230, the horizontal polarization component undergoes a 180-degree phase shift, which flips the polarization direction of laser beam 1280 to the opposite side of normal vector \hat{n}. For example, when the polarization direction of laser beam 1280 is initially inclined by 30 degrees in a counter-clockwise direction from normal vector \hat{n}, mirror 1280 will flip the polarization direction of laser beam 1280 to be inclined by 30 degrees in a clockwise direction from normal vector \hat{n}. This description of polarization flipping, as well as subsequent descriptions of polarization flipping, do not take into account the polarization dependence of Fresnel reflections, which could change the polarization-inclination-angle produced by mirror 1280. Without departing from the scope hereof, polarization rotation with, e.g., a halfwave plate may be used to compensate for the polarization dependence of Fresnel reflections.

Referring again to FIG. 11, in the depicted scenario, beam propagation in module 1100 takes place in a propagation plane. Laser beam 1180 enters module with an input polarization direction Pᵢₙ that is orthogonal to the propagation plane. A polarization rotator 1110 rotates the polarization to an obliquely oriented polarization direction P_{R}. Polarization rotator 1110 may be a halfwave plate. Next, a non-polarizing beamsplitter 1120 splits laser beam 1180 into two laser beams 1188 and 1189. Beamsplitter 1120 may split laser beam 1180 evenly. Laser beam 1188 is portion of laser beam 1180 that is reflected by beamsplitter 1120, while laser beam 1189 is portion of laser beam 1180 that is transmitted by beamsplitter 1120. Since laser beam 1188 undergoes a reflection at beamsplitter 1120, its polarization direction is flipped with respect to the normal vector to the propagation plane, resulting in a flipped polarization direction P_{F}. Laser beam 1189, on the other hand, maintains polarization direction P_{R} through beamsplitter 1120. However, laser beam 1189 undergoes two reflections, at respective mirrors 1130, in order to exit module 1100 in a propagation direction parallel to that of laser beam 1188. The first of these two reflections flips the polarization direction of laser beam 1189 to P_{F}, whereafter the second reflection flips the polarization direction back to P_{R}. Consequently, the polarization directions of laser beams 1188 and 1189 become symmetrically inclined with respect to the normal vector of the propagation plane of module 1100.

In an alternative embodiment, laser beam 1180 enters module 1100 with an obliquely oriented polarization direction. In this alternative embodiment, module 1100 may omit polarization rotator 1110. However, regardless of the initial polarization direction of laser beam 1180, polarization rotator 1110 may be present to allow for easy adjustment of the polarization-inclination angle, which may be useful for optimizing corresponding embodiments of apparatus 100 for a given laser annealing application.

Module 1100 is readily generalized to more complex beam propagation in multiple planes. Module 1100 may also be generalized to a different number of reflections, provided that one of laser beams 1188 and 1189 undergoes an even number of reflections (or zero reflections) while the other one of laser beams 1188 and 1189 undergoes an odd number of reflections.

In order to produce the power needed for laser annealing, apparatus 100 may include two or more laser sources 120. In such embodiments of apparatus 100, it may be advantageous to mix the respective laser beams produced by these laser sources 120. Such beam mixing reduces or eliminates any effects that otherwise may arise from the plurality of laser sources 120 potentially differing in performance.

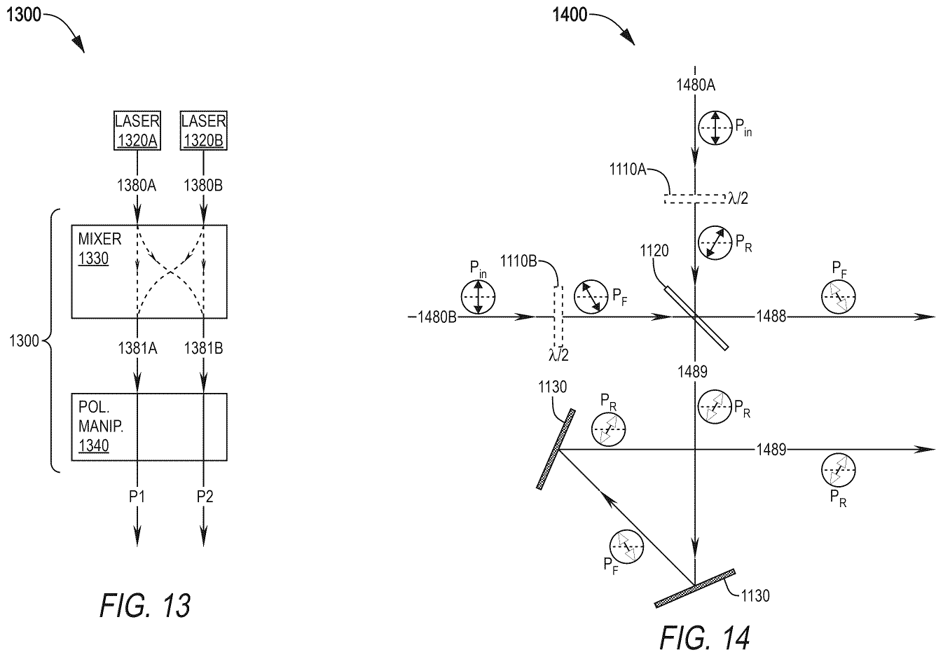

FIG. 13 illustrates one beam-mixing module 1300 that mixes two input laser beams to produce symmetrically inclined polarization components that each contain contributions from each of the two input laser beams. Module 1300 may be implemented in beam-delivery subsystem 130 of apparatus 100. Module 1300 receives two pulsed laser beams 1380A and 1380B generated by respective laser sources 1320A and 1320B (embodiments of laser sources 120). Laser beams 1380A and 1380B may be nominally identical. Module 1300 includes a mixer 1330 and a polarization manipulator 1340. Mixer 1330 mixes laser beams 1380A and 1380B to produce laser beams 1381A and 1381B. Each of laser beams 1381 and 1381B contains contributions from each of laser beams 1380A and 1380B. Laser beams 1380A and 1380B may contribute evenly to each of laser beams 1381A and 1381B. Polarization manipulator 1340 manipulates the polarization directions of laser beams 1381A and 1381B to produce symmetrically inclined polarization components P1 and P2.

In the embodiment depicted in FIG. 13, polarization manipulator 1340 is separate from mixer 1330. In this embodiment, polarization manipulator 1340 may simply be a halfwave plate inserted in one of laser beams 1381A and 1381B. In another embodiment, not depicted, the actions of mixer 1330 and polarization manipulator 1340 are at least partly integrated with each other.

FIG. 14 illustrates another beam-mixing module 1400 that partly integrates mixing and polarization manipulation functions to produce a pair of output laser beams with symmetrically inclined polarization directions. Module 1400 is an embodiment of module 1300. Module 1400 may be viewed as an extension of module 1100 wherein two laser beams are incident on beamsplitter 1120.

Module 1400 receives two linearly polarized laser beams 1480A and 1480B. In the depicted embodiment of module 1400, (a) beam propagation takes place in a common plane, (b) laser beams 1480A and 1480B are initially polarized orthogonally to this plane, and (c) module 1400 includes a polarization rotators 1110A and 1110B in each of laser beams 1480A and 1480B. The polarization direction of laser beam 1480A is rotated by the associated polarization rotator 1110A to yield polarization direction P_{R} (discussed above in reference to FIG. 11). Meanwhile, the polarization direction of laser beam 1480B is rotated by the associated polarization rotator 1110B to yield polarization direction P_{F} (also discussed above in reference to FIG. 11). Next, laser beams 1480A and 1480B are mixed by beamsplitter 1120. Beamsplitter 1120 produces two laser beams 1488 and 1489 from laser beams 1480A and 1480B. Each of laser beams 1488 and 1489 contains contributions from each of laser beams 1480A and 1480B. Each of laser beams 1480A and 1480B may be split evenly between laser beams 1488 and 1489.

Laser beam 1488 contains (a) a reflected portion of laser beam 1480A that has been flipped to polarization direction P_{F} by beamsplitter 1120 and (b) a transmitted portion of laser beam 1480B that has maintained polarization direction P_{F} through beamsplitter 1120. Laser beam 1489 contains (a) a reflected portion of laser beam 1480B that has been flipped to polarization direction P_{R} by beamsplitter 1120 and (b) a transmitted portion of laser beam 1480A that has maintained polarization direction P_{R} through beamsplitter 1120. Laser beam 1489 is reflected by two mirrors 1130, as discussed above in reference to laser beam 1189 in module 1100, to exit module 1400 with polarization direction P_{R}.

In a manner similar to that discussed for laser beam 1180 in module 1100, one or both of laser beams 1480A and 1480B may enter module 1400 with an obliquely oriented polarization direction, in which case module 1400 may omit the associated polarization rotator(s) 1110A or 1110B. Module 1400 is readily generalized to more complex beam propagation in multiple planes.

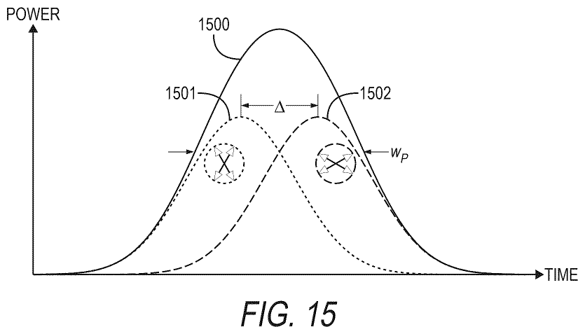

FIG. 15 illustrates a composite laser pulse 1500 that contains temporally offset sub-pulses with different respective polarization configurations. Line beam 184 produced by apparatus 100 and method 200 may include or consist of composite laser pulses 1500. Composite laser pulse 1500 contains two sub-pulses 1501 and 1502 that overlap temporally but are offset from each other by a delay Δ. Each of sub-pulses 1501 and 1502 contains a pair of symmetrically inclined polarization components, with respect to short axis S of line beam 184. However, the polarization-inclination angle is different for sub-pulses 1501 and 1502. Consequently, the net-polarization of line beam 184 changes dynamically within each composite laser pulse 1500. This intra-pulse variation can be achieved while ensuring that any net-polarization is along either short axis S or long axis L. Intra-pulse variation may be advantageous for microstructure development. In one example, sub-pulse 1501 has a net-polarization along short axis S and sub-pulse 1502 has a net-polarization along long axis L. Each of sub-pulses 1501 and 1502 may have properties similar to those of pulse 600 (FIG. 6) or pulse 700 (FIG. 7).

Composite laser pulse 1500 is readily generalized to containing more than two sub-pulses, each containing two symmetrically inclined polarization components. In one embodiment, composite laser pulse 1500 is composed of sub-pulses that are each composed of a pair of symmetrically inclined polarization components. In another embodiment, such pairs of symmetrically inclined polarization components constitute at least 90% of the energy of composite laser pulse 1500.

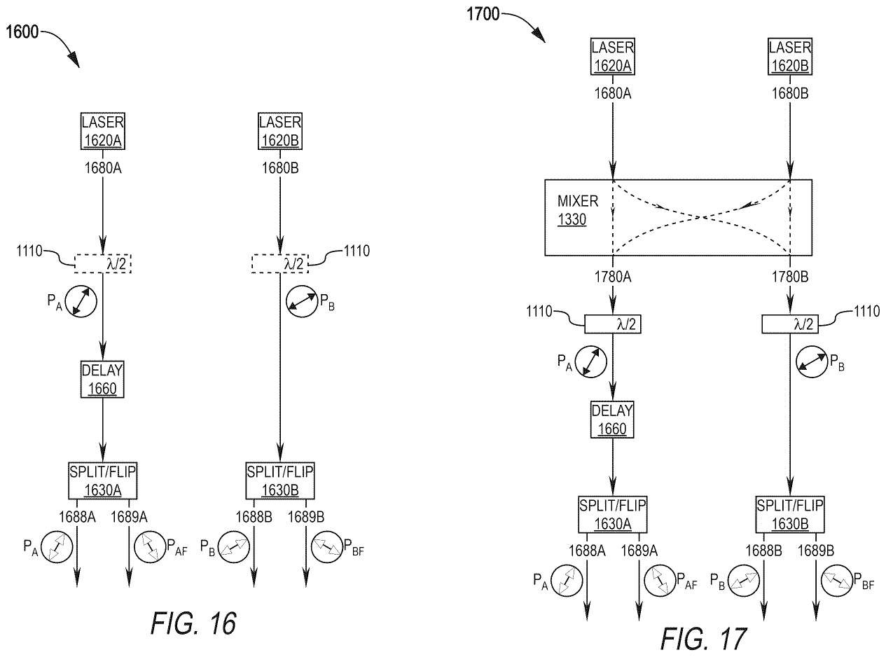

FIG. 16 illustrates one laser system 1600 that produces two pairs of symmetrically inclined polarization components from two linearly polarized input laser beams 1680A and 1680B. Laser system 1600 may be implemented in laser system 110 of apparatus 100 to produce composite laser pulses 1500. Laser system 1600 includes two laser sources 1620A and 1620B. Laser sources 1620A and 1620B generate laser beams 1680A and 1680B, respectively. Laser beams 1680A and 1680B may be nominally identical. In one embodiment, laser system 1600 includes a polarization rotator 1110 in the path of at least one of laser beams 1680A and 1680B in order to give laser beams 1680A and 1680B different respective polarization directions P_{A} and P_{B}. In another embodiment, laser sources 1620A and 1620B generate laser beams 1680A and 1680B with polarization directions P_{A} and P_{B}, respectively.

Laser beams 1680A and 1680B are processed by respective beam-splitting and polarization-flipping module 1630A and 1630B. Each of polarization-flipping module 1630A and 1630B may be in the form of module 1100. In this manner, each of laser beams 1680A and 1680B is split into two symmetrically inclined polarization components. More specifically, laser beam 1680A is split into a laser beam 1688A with polarization direction P_{A} and a laser beam 1689A with a polarization direction P_{AF} that is flipped relative to polarization direction P_{A}, as discussed above in reference to FIG. 11 and laser beams 1188 and 1189. Similarly, laser beam 1680B is split into a laser beam 1688B with polarization direction P_{B} and a laser beam 1689B with a polarization direction P_{BF} that is flipped relative to polarization direction P_{B}. Before module 1630A, laser beam 1680A passes through a delay module 1660 (e.g., a longer optical path) such that laser beams 1688A and 1689A are delayed relative to laser beams 1688B and 1689B. As an alternative to delay module 1660, the pulse generation of laser source 1620A could be delayed relative to that of laser source 1620B.

Laser beams 1688A, 1689A, 1688B, and 1689B may subsequently be combined into line beam 184 by, e.g., module 800 or its alternative non-imaging embodiment.

Laser system 1600 is readily extended to the generation of three or more sub-pulses within each composite laser pulse 1500. When generated by laser system 1600, each sub-pulse of composite laser pulse 1500 is generated by a different respective laser source. Laser system 110 of apparatus 100 may implement beam mixing to ensure that each laser source instead contributes to each sub-pulse.

FIG. 17 illustrates one laser system 1700 that produces two pairs of symmetrically inclined polarization components from the mixed outputs of two linearly polarized laser sources. Laser system 1700 is an extension of laser system 1600 that further includes mixer 1330. Mixer 1330 mixes laser beams 1680A and 1680B to produce laser beams 1780A and 1780B. Each of laser beams 1680A and 1680B may be divided evenly between laser beams 1780A and 1780B. At least one of laser beams 1780A and 1780B is subjected to polarization rotation by a polarization rotator 1110, such that laser beams 1780A and 1780B have different respective polarization directions P_{A} and P_{B}. Next, laser beam 1780A and 1780B are processed by beam-splitting and polarization-flipping modules 1630A and 1630B as well as delay module 1660, as discussed for laser beams 1680A and 1680B in reference to FIG. 16. The output laser beams of laser system 1700 are similar to those of laser system 1600 except that each output laser beam of laser system 1700 contains a contribution from each of laser sources 1620A and 1620B.

In an alternative embodiment, beam-mixing in laser system 1700 may be at least partly integrated with the actions of beam-splitting and polarization-flipping, for example using concepts similar to those employed in beam-mixing module 1400.

Without departing from the scope hereof, the delay between different sub-pulses of composite laser pulse 1500 may be zero. For example, delay Δ between sub-pulses 1501 and 1502 may be zero. This can be achieved, for example, by adjusting the delay imposed by delay module 1660 in laser system 1600 or 1700 or omitting delay module 1660.

Laser annealing method 200 is particularly useful when utilizing solid-state lasers, since solid-state lasers typically generate linearly polarized laser radiation. However, laser annealing method 200 may also be useful when using excimer lasers. Although excimer laser beams tend to be non-polarized, weak polarization may exist, for example as a result of preferential attenuation of a specific polarization direction by an optical element encountered by the excimer laser beam outside the excimer laser itself.

The present invention is described above in terms of a preferred embodiment and other embodiments. The invention is not limited, however, to the embodiments described and depicted herein. Rather, the invention is limited only by the claims appended hereto.

What is claimed is:

1. A laser annealing method, comprising steps of:
generating linearly-polarized pulsed laser radiation using one or more pulsed laser sources;
forming a pulsed line beam from the linearly-polarized pulsed laser radiation, the line beam having mutually-orthogonal short and long axes, the line beam containing a pair of linear polarization components that are symmetrically inclined with respect to the short axis and collaboratively produce a non-zero net-polarization along the long or short axis of the line beam; and
laser annealing a target substrate by scanning the target substrate with the line beam, wherein each of a plurality of to-be-annealed locations on the target substrate is exposed to a series of pulses of the line beam.

2. The laser annealing method of claim 1, wherein each pulse of the line beam contains the pair of linear polarization components and is characterized by the non-zero net-polarization along the long axis or the short axis.

3. The laser annealing method of claim 1, wherein the pair of linear polarization components have the same pulse energy to within 20 percent.

4. The laser annealing method of claim 1, wherein the pair of linear polarization components are temporally synchronized with each other in each pulse of the line beam.

5. The laser annealing method of claim 1, wherein each pulse of the line beam is characterized by a pulse width and, for each pulse of the line beam, respective temporal centers of the pair of linear polarization components are synchronized with each other to within 10 percent of the pulse width.

6. The laser annealing method of claim 1, wherein each linear polarization component of the pair is inclined by less or more than 45 degrees with respect to the short axis.

7. The laser annealing method of claim 1, wherein the line beam is characterized by greater angular distribution in the short axis than in the long axis.

8. The laser annealing method of claim 1, wherein the non-zero net-polarization of the line beam is parallel with the short or long axis to within 5 degrees.

9. The laser annealing method of claim 1, wherein the non-zero net-polarization of the line beam is characterized by a short-to-long-axis polarization extinction ratio in the range between 60:40 and 40:60.

10. The laser annealing method of claim 1, wherein the pair of linear polarization components constitute at least 90 percent of a pulse energy of the pulses.

11. The laser annealing method of claim 1, wherein the pair of linear polarization components is one instance of a plurality of instances of linear polarization components included in the line beam, each of the instances being characterized by a different respective polarization-inclination-angle by which the pair of linear polarization components for the instance are symmetrically inclined with respect to the short axis, one of the instances of the pair of linear polarization components being temporally delayed relative to another one of the instances of the pair of linear polarization components.

12. The laser annealing method of claim 11, wherein the plurality of instances of the pair of linear polarization components together constitute at least 90 percent of a pulse energy of the pulses.

13. The laser annealing method of claim 1, wherein the step of forming includes splitting a pulsed laser beam into (a) a first laser beam that contributes to one of the pair of linear polarization components and (a) second laser beam that contributes to the other one of the pair of linear polarization components.

14. The laser annealing method of claim 13, wherein the step of forming further includes subjecting the first laser beam to zero reflections or an even number of reflections, while subjecting the second laser beam to an odd number of reflections, whereby respective linear net-polarizations of the first and second laser beams become symmetrically inclined with respect to the short axis.

15. The laser annealing method of claim 13, wherein the one or more pulsed laser sources include two laser sources, and the step of generating includes mixing outputs of the two laser sources such that each of the two laser sources contributes to both of the first and second laser beams.

16. The laser annealing method of claim 1, wherein the linearly-polarized pulsed laser radiation generated by each of the one or more pulsed laser sources contains two orthogonal polarization components of unequal power.

17. The laser annealing method of claim 1, further comprising adjusting a polarization-inclination-angle by which the pair of linear polarization components are symmetrically inclined with respect to the short axis.

18. The laser annealing method of claim 1, wherein the linearly-polarized pulsed laser radiation generated by each of the one or more pulsed laser sources is ultraviolet.

19. A laser annealing method, comprising steps of:
generating linearly-polarized pulsed laser radiation using one or more pulsed laser sources;
forming a pulsed line beam from the linearly-polarized pulsed laser radiation, the line beam having mutually-orthogonal short and long axes, the line beam containing a pair of linear polarization components that are (a) symmetrically inclined with respect to the short and long axes and (b) temporally synchronized with each other in each pulse of the line beam; and
laser annealing a target substrate by scanning the target substrate with the line beam, wherein each of a plurality of to-be-annealed locations on the target substrate is exposed to a series of pulses of the line beam.

20. The laser annealing method of claim 19, wherein each pulse of the line beam is characterized by a pulse width and, for pulse of the line beam, respective temporal centers of the pair of linear polarization components are synchronized with each other to within 10 percent of the pulse width.

21. The laser annealing method of claim 19, wherein the line beam is characterized by greater angular distribution in the short axis than in the long axis.

22. The laser annealing method of claim 19, wherein the pair of linear polarization components have the same pulse energy to within 10 percent.

23. The laser annealing method of claim 19, wherein the pair of linear polarization components constitute at least 90 percent of a pulse energy of the pulses.

24. The laser annealing method of claim 19, wherein the pair of linear polarization components is one instance of a plurality of instances of the pair of linear polarization components included in the line beam, each of the instances being characterized by a different respective polarization-inclination-angle by which the pair of linear polarization components for the instance are symmetrically inclined with respect to the short axis, one of the instances of the pair of linear polarization components being temporally delayed relative to another one of the instances of the pair of linear polarization components.

25. The laser annealing method of claim 24, wherein the plurality of instances of the pair of linear polarization components together constitute at least 90 percent of a pulse energy of the pulses.

26. The laser annealing method of claim 19, wherein the step of forming includes splitting a pulsed laser beam into (a) a first laser beam that contributes to one of the pair of linear polarization components and (a) second laser beam that contributes to the other one of the pair of linear polarization components.

27. The laser annealing method of claim 26, wherein the step of forming further includes subjecting the first laser beam to zero reflections or an even number of reflections, while subjecting the second laser beam to an odd number of reflections, whereby respective linear net-polarizations of the first and second laser beams become symmetrically inclined with respect to the short axis.

28. The laser annealing method of claim 26, wherein the one or more pulsed laser sources include two laser sources, and the step generating includes mixing outputs of the two laser sources such that each of the two laser sources contributes to both of the first and second laser beams.

29. The laser annealing method of claim 19, wherein the linearly-polarized pulsed laser radiation generated by each of the one or more pulsed laser sources contains two orthogonal polarization components of unequal power.

30. The laser annealing method of claim 19, further comprising adjusting a polarization-inclination-angle by which the pair of linear polarization components are symmetrically inclined with respect to the short axis.

31. The laser annealing method of claim 19, wherein the linearly-polarized pulsed laser radiation generated by each of the one or more pulsed laser sources is ultraviolet.
